(19) United States
(12) Patent Application Publication
(10) Pub. No.: US 2016/0054879 A1
(43) Pub. Date: Feb. 25, 2016

(54) PORTABLE ELECTRONIC DEVICES AND METHODS FOR OPERATING USER INTERFACES

(71) Applicant: Acer Incorporated, New Taipei City (TW)

(72) Inventors: Jhao-Dong CHIU, New Taipei City (TW); Sheng-Feng CHIU, New Taipei City (TW)

(21) Appl. No.: 14/624,978

(22) Filed: Feb. 18, 2015

(30) Foreign Application Priority Data
Aug. 19, 2014 (TW) 103128385

(51) Int. Cl. G06F 3/0486; G06F 3/0484; G06F 3/0481; G06F 3/0488

(52) U.S. Cl. CPC G06F 3/0486; G06F 3/0488; G06F 3/04842; G06F 3/04815

(57) ABSTRACT

A portable electronic device includes a display unit, a touch sensing module and a processing unit. The display unit displays a user interface. The user interface includes a plurality of display objects. The display objects respectively include a first display surface and a second display surface. The first display surface generally faces toward the user. The touch sensing module senses a drag event corresponding to a touch object. The processing unit generates the user interface, and changes the distribution of the display objects by switching the first display surface to the second display surface by a rotated effect according to a drag direction of the drag event.

### CROSS REFERENCE TO RELATED APPLICATIONS

This application claims priority of Taiwan Patent Application No. 103128385, filed on Aug. 19, 2014, the entirety of which is incorporated by reference herein.

### BACKGROUND OF THE INVENTION

1. Field of the Invention

The application relates in general to a portable electronic device and method for operating a user interface, and in particular to a portable electronic device and method for operating a user interface for changing the display surface of a display object using a rotated effect according to the direction of a finger drag input, wherein the display object is shown in three-dimensional effect.

2. Description of the Related Art

These days, due to the rapid development of electronic devices, users can implement various functions using their electronic devices. In general, the main screen interface is used to implement a specific application by touching a specific icon, or switching to another screen of the user interface, according to a drag event. However, when a user wants to perform some common functions, such as, copy or delete, he/she has to perform some complex gestures which is inconvenient. Thus, how to provide a better operation for the user in that situation is a problem which needs to be solved immediately.

### BRIEF SUMMARY OF INVENTION

An embodiment of the invention provides a portable electronic device, including a display unit, a touch-sensing module, and a processing unit. The display unit displays a user interface. The user interface includes a plurality of display objects which are shown in a three-dimensional effect. The display objects respectively comprise a first display surface and a second display surface, and the first display surface generally faces toward the user. The touch sensing module senses a drag event corresponding to a touch object. The processing unit generates the user interface, and changes the distribution of one of the display objects by switching from the first display surface to the second display surface with a rotating effect in the direction of the drag event.

Another embodiment of the invention provides a method for operating a user interface, adapted to a portable electronic device, including: displaying the user interface, wherein the user interface comprises a plurality of display objects which are shown in three-dimensional effect, the display objects respectively comprise a first display surface and a second display surface, and the first display surface generally faces toward the user; sensing a drag event corresponding to a touch object; changing a distribution of one of the display objects by switching from the first display surface to the second display surface by a rotated effect according to a drag direction of the drag event.

### BRIEF DESCRIPTION OF DRAWINGS

The invention can be more fully understood by reading the subsequent detailed description and examples with references made to the accompanying drawings, wherein:

FIG. 1 is a block diagram of an electronic device in accordance with an embodiment of the invention;

FIGS. 2A, 2B and 2C are schematic diagrams of operations of a user interface in accordance with an embodiment of the invention;

FIG. 3 is a schematic diagram of operations of a user interface in accordance with another embodiment of the invention;

FIG. 4 is a schematic diagram of a user interface in accordance with an embodiment of the invention;

FIG. 5 is a flow chart of a method for operating a user interface in accordance with an embodiment of the invention.

### DETAILED DESCRIPTION OF INVENTION

Further areas in which the present devices and methods can be applied will become apparent from the following detailed description. It should be understood that the detailed description and specific examples, while indicating exemplary embodiments of the portable electronic devices and the methods for operating user interfaces, are intended for the purposes of illustration only and are not intended to limit the scope of the invention.

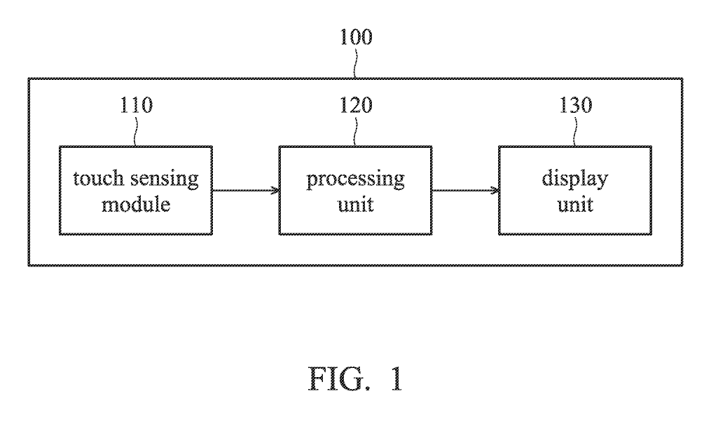

FIG. 1 is a block diagram of an electronic device in accordance with an embodiment of the invention. The portable electronic device 100 includes a touch sensing module 110, a processing unit 120 and a display unit 130. The touch sensing module 110 senses a drag event corresponding to a touch object. The touching object can be a finger of the user, a stylus, or any object that can enable the touch-sensing electrodes. The processing unit 120 generates the user interface and changes the display surface of the display objects by switching the first display surface to the second display surface by a rotated effect according to a drag direction of a drag event. The display unit displays a user interface. The user interface includes a plurality of display objects which are shown in the three-dimensional effect.

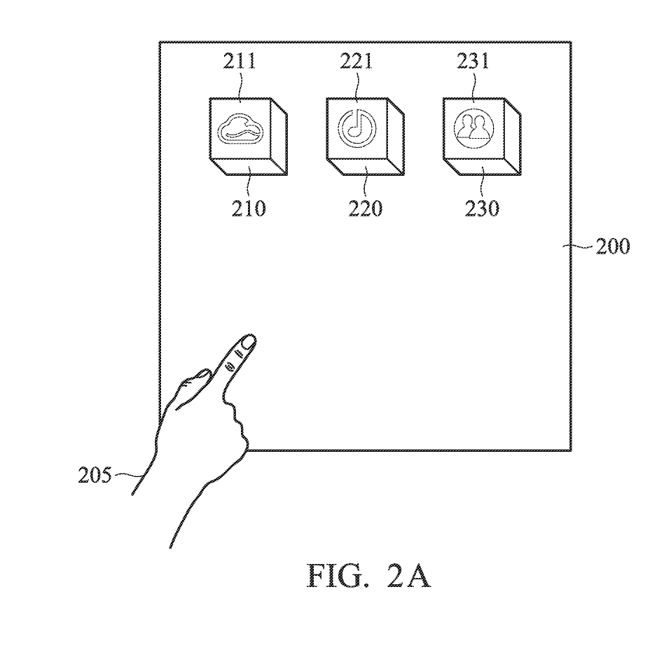

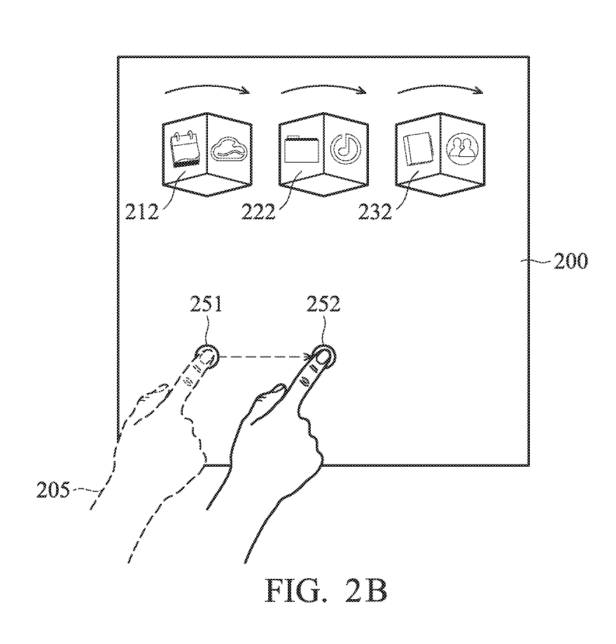

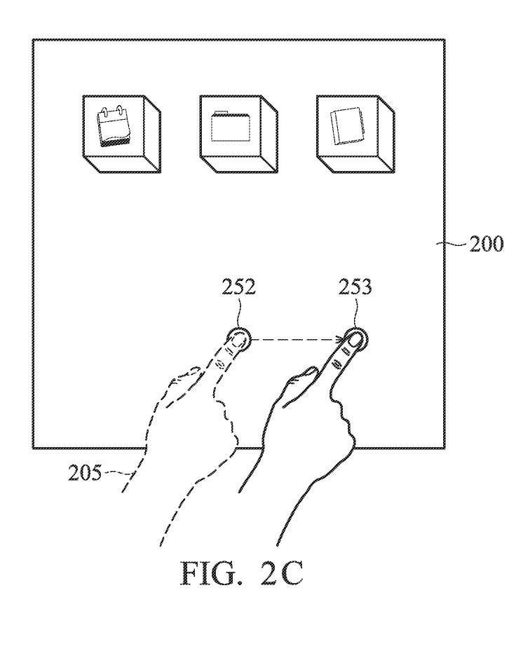

FIGS. 2A, 2B and 2C are schematic diagrams of operations of a user interface in accordance with an embodiment of the invention. As shown in FIG. 2A, the user interface 200 includes the display objects 210, 220 and 230 which are shown in the three-dimension effect. The display objects 210, 220 and 230 respectively include a plurality of display surface. The first display surfaces 211, 221 and 231 generally face the user. The other display surfaces of the display object 210, 220 and 230 include different icons. The icons are used to enable different applications or operating functions, or can be a blank display surface with nothing (e.g. unable to enable any application or operating function). It should be noted that the display objects described in the embodiment are shown as a cube, otherwise, they can also be other polyhedrons, but the present invention is not limited thereto.

Please refer to FIG. 2B. As shown in FIG. 2B, when the touch sensing module 110 sense that the user's finger 205 is touching the screen on a point 251, and performs a dragging motion from point 251 to point 252, the processing unit 120 records the track of the dragging motion, and rotates the display objects 210, 220 and 230 according to the direction and the length of the track. The direction of the track equals the direction of the rotation. For example, when the direction of the track is from left to right, the display object 210, 220 and 230 display the display interface which is on the left side of the original display interface. The ratio of the length of the track and the rotation angle can be defined by the user. For example, the rotation angle is 90° when the length of the track is 4 cm, and the rotation angle is 135° when the length of the track is 6 cm, and so on. Furthermore, when the display object 210, 220 and 230 are rotating, the display object 210, 220 and 230 display a portion of the first display interface 211, 221, 231 and a portion of the second display interface 212, 222, 232, and changes the ratio of the display area of the first display interface 211, 221, 231 and a portion of the second display interface 212, 222, 232 according to the length of the track. For example, the ratio of the display area of the first display interface 211, 221, 231 is 75% and the ratio of the display area of the second display interface 212, 222, 232 is 25% when the length of the track is 1 cm. In other words, as shown in FIG. 2C, the display unit 130 only displays the second display interface 212, 222, 232 rather than the first display interface 211, 221, 231 when the length of the track is 4 cm (e.g. the finger 205 is dragged to 253).

Furthermore, the functions of the icons can be different due to different user interfaces. For example, the icons are respectively corresponded to different applications when the user interface is displaying the main screen, and the icons are respectively corresponded to different operating function when the user interface is displaying an application.

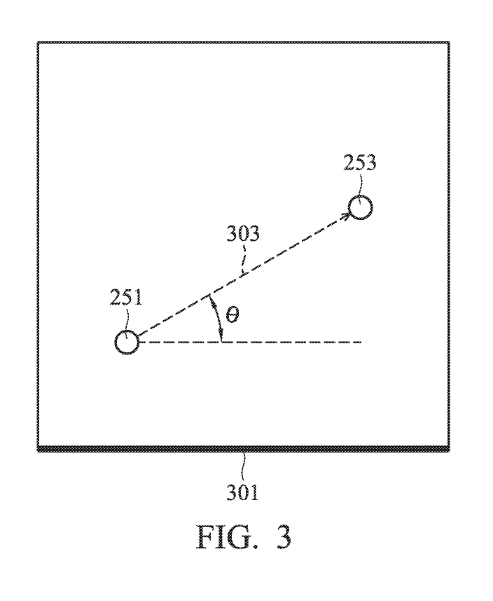

Please refer to FIG. 3, FIG. 3 is a schematic diagram of operations of a user interface in accordance with another embodiment of the invention. As shown in FIG. 3, the processing unit 120 further determines the rotation direction of the display object 210, 220, 230 according to the track 303 and an angle θ with the predetermined edge 301. For example, the display object 210, 220, 230 are rotated in a horizontal direction (e.g. from left to right or from right to left) when the angle θ is less than 45°. The display object 210, 220, 230 are rotated in a vertical direction (e.g. from down to up or from up to down) when the angle θ is equal to or greater than 45°. The horizontal direction means the axis of the display object 210, 220, 230 are vertical to the predetermined edge 301, and the display object 210, 220, 230 are rotated clockwise or anticlockwise according to the direction of the track. The vertical direction means the axis of the display object 210, 220, 230 are parallel to the predetermined edge 301, and the display object 210, 220, 230 are rotated clockwise or anticlockwise according to the direction of the track.

Furthermore, the user can implement complex operating functions by combining the rotation of the horizontal direction and the vertical direction. For example, the user can change to display different user interfaces by rotating in the horizontal direction, and enable a delete function or renew the applications corresponding to the first display surfaces 211, 221, 231 of the display objects 210, 220, 230 by rotating in the vertical direction when the user interface is a main screen interface. The user can implement the operating functions of Pen, Eraser, Spray gun, Straight line by rotating in the horizontal direction, and change the size of the Pen, Eraser, Spray gun, Straight line and even the operating function of “copy and paste” by rotating in the vertical direction when the user interface is a “Microsoft Paint”. It should be noted that the operating functions described above are used to be the examples, but they are not intended to limit the present invention.

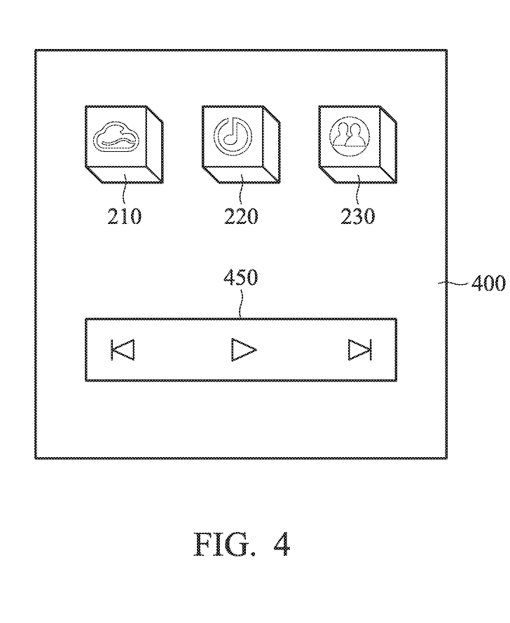

Please refer to FIG. 4. FIG. 4 is a schematic diagram of a user interface in accordance with an embodiment of the invention. As shown in FIG. 4, the user interface 400 includes a display object 450 which is shown in a two-dimensional effect, and the display objects 210, 220, 230 which are shown in a three-dimensional effect at the same time. The display objects 210, 220, 230 are rotated with the dragging motion of the user on the touch sensing module 110, but the display object 450 will have no response to the dragging motion.

According to another embodiment of the invention, the processing unit 120 changes the distribution of the display object 210, 220, 230 according to the touching location corresponding to the drag event. For example, the processing unit 120 only changes the distribution of the display object 210 when the starting location of the drag event is on the display object 210. Or the processing unit 120 changes the distributions of the display object 210, 220, 230 at the same time when the starting location of the drag event is in a blank or a predetermined area of the user interface, which means the starting location is not on the display object 210, 220, 230. In another embodiment, the first display surface of the display objects are all switched to the second display surface without considering the starting location.

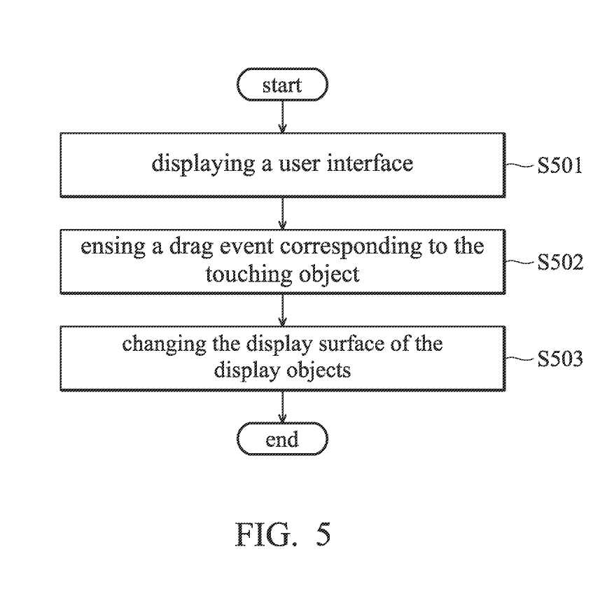

Please refer to FIG. 5 with FIG. 1. FIG. 5 is a flow chart of a method for operating a user interface in accordance with an embodiment of the invention. In step S501, the electronic device 100 displays a user interface. The user interface includes a plurality of display objects which are shown in three-dimensional effect. The display objects include a plurality of display surface, and the first display surface generally faces toward the user. The display surfaces of the display object respectively correspond to different icons, and the icons are used to enable different applications or operating functions, or can be a blank display surface with nothing (e.g. unable to enable any application or operating function). In step S502, the touch sensing module 110 senses a drag event corresponding to the touching object. The touching object can be a finger of the user, stylus, or any object that can enable the touch sensing electrodes. In step S503, the processing unit 120 changes the display surface of the display objects by switching the first display surface to the second display surface by a rotated effect according to a drag direction of a drag event.

According to an embodiment of the invention, when the touch sensing module 110 senses that the finger 205 of the user touches the screen on a point 251, and enables a dragging motion from the point 251 to a point 252, the processing unit 120 records the track of the dragging motion, and rotates the display object 210, 220, 230 according to the direction and the length of the track. The direction of the track equals to the direction of the rotation. For example, when the direction of the track is from left to right, the display object 210, 220, 230 display the display interface which is on the left side of the original display interface. The ratio of the length of the track and the rotation angle can be defined by the user. For example, the rotation angle is 90° when the length of the track is 4 cm. Furthermore, when the display object 210, 220, 230 are rotating, the ratio of the first display surface and the second display surface of the display object 210, 220, 230 will be changed according to the length of the track. For example, the display unit 130 only displays the second display interface 212, 222, 232 rather than the first display interface 211, 221, 231 when the length of the track is 4 cm.

According to another embodiment of the invention, the functions of the icons can be different due to different user interfaces. For example, the icons are respectively corresponded to different applications when the user interface is a main screen interface, and the icons are respectively corresponded to different operating function when the user interface is an application.

According to another embodiment of the invention, the processing unit 120 further determines the rotation direction of the display object according to the track and an angle θ with the predetermined edge 301. For example, the display object 210, 220, 230 are rotated in a horizontal direction when the angle θ is less than 45°. Conversely, the display object 210, 220, 230 are rotated in a vertical direction when the angle θ is equal to or greater than 45°.

Furthermore, the user can implement complex operating functions by combining the rotation of the horizontal direction and the vertical direction. For example, the user can change to display different user interfaces by rotating in the horizontal direction, and enable a delete function or renew the applications corresponding to the first display surface 211, 221, 231 of the display object 210, 220, 230 by rotating in the vertical direction when the user interface is a main screen interface. The user can implement the operating functions of Pen, Eraser, Spray gun, Straight line by rotating in the horizontal direction, and change the size of the Pen, Eraser, Spray gun, Straight line and even the operating function of “copy and paste” by rotating in the vertical direction when the user interface is a Paint. It should be noted that the operating functions described above are used as the examples, but the present invention is not limited thereto.

According to another embodiment of the invention, the processing unit 120 changes the distribution of the display object 210, 220, 230 according to the touching location corresponding to the drag event. For example, the processing unit 120 only changes the distribution of the display object 210 when the starting location of the drag event is on the display object 210. Or the processing unit 120 changes the distributions of the display object 210, 220, 230 at the same time when the starting location of the drag event is in a blank or a predetermined area of the user interface, which means the starting location is not on the display object 210, 220, 230. In another embodiment, the first display surface of the display objects are all switched to the second display surface not with standing the starting location.

As described above, an embodiment of the invention provides an electronic device and a method for operating the user interface, in which the display objects of the user interface are shown in a three-dimensional effect. The user can use a sample dragging motion to display different applications, and further can enable different operating functions according to the direction and the touching location of the dragging motion. In this way, the user can enable a complex operation or more functions in the electronic device which has a small screen, and make the user interface become simpler. That helps the user to operate the user interface more directly, and the experience for the user is improved.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. A portable electronic device, comprising:
a display unit, displaying a user interface, wherein the user interface includes a plurality of display objects which are shown in a three-dimensional effect, the display objects respectively comprise a first display surface and a second display surface, and the first display surface generally faces the user;
a touch sensing module, sensing a drag event corresponding to a touch object; and
a processing unit, generating the user interface, and changing a distribution of one of the display objects by switching from the first display surface to the second display surface by a rotated effect according to a drag direction of the drag event.

2. The portable electronic device as claimed in claim 1, wherein the first display surface corresponds to a first application and the second display surface is corresponds to a second application.

3. The portable electronic device as claimed in claim 1, wherein the first display surface is corresponded to a first operating function and the second display surface is corresponded to a second operating function.

4. The portable electronic device as claimed in claim 1, wherein the processing unit further determines a rotation direction of the display objects according to an angle between the drag direction and a predetermined edge.

5. The portable electronic device as claimed in claim 4, wherein the display objects are rotated according to the drag direction, and the rotation direction of the display objects is parallel to the predetermined edge when the angle is less than a predetermined angle, and the display objects are rotated according to the drag direction, and the rotation direction of the display object is vertical to the predetermined edge when the angle is greater than or equal to the predetermined angle.

6. The portable electronic device as claimed in claim 1, wherein the user interface displays a portion of the first display surface and a portion of the second display surface while the display objects are rotating.

7. The portable electronic device as claimed in claim 1, wherein the user interface further comprises a plurality of display objects which are shown in a two-dimensional effect.

8. The portable electronic device as claimed in claim 1, wherein the processing unit further selects one of the display objects according to a touching location corresponding to the drag event.

9. The portable electronic device as claimed in claim 8, wherein the processing unit further changes a distribution of the display objects according to the touching location and the drag direction when the touching location is not on any of the display objects.

10. The portable electronic device as claimed in claim 1, wherein the processing unit further changes a distribution of the other display objects by switching from the first display surface to the second display surface by the rotated effect according to the drag direction of the drag event.

11. A method for operating a user interface, adapted to an portable electronic device, comprising:
displaying the user interface, wherein the user interface comprises a plurality of display objects which are shown in three-dimensional effect, the display objects respectively comprise a first display surface and a second display surface, and the first display surface generally faces toward the user;
sensing a drag event corresponding to a touch object;
changing a distribution of one of the display objects by switching from the first display surface to the second display surface by a rotated effect according to a drag direction of the drag event.

12. The method as claimed in claim 11, wherein the first display surface is corresponded to a first application and the second display surface is corresponded to a second application.

13. The method as claimed in claim 11, wherein the first display surface is corresponded to a first operating function and the second display surface is corresponded to a second operating function.

14. The method as claimed in claim 11, wherein the step for changing the distribution of the display object further comprises:
determines a rotation direction of the display objects according to an angle between the drag direction and a predetermined edge.

15. The method as claimed in claim 14, wherein the display objects are rotated according to the drag direction, and the rotation direction of the display objects is parallel to the predetermined edge when the angle is less than a predetermined angle, and the display objects are rotated according to the drag direction, and the rotation direction of the display object is vertical to the predetermined edge when the angle is greater than or equal to the predetermined angle.

16. The method as claimed in claim 11, wherein the user interface displays a portion of the first display surface and a portion of the second display surface while the display objects are rotating.

17. The method as claimed in claim 11, wherein the user interface further comprises a plurality of display objects which are shown in a two-dimensional effect.

18. The method as claimed in claim 11, wherein the step for changing the distribution of the display object further comprises:
selecting one of the display objects according to a touching location corresponding to the drag event.

19. The method as claimed in claim 18, wherein the step for changing the distribution of the display object further comprises:
changing a distribution of the display objects according to the touching location and the drag direction when the touching location is not on any of the display objects.

20. The method as claimed in claim 11, wherein the step for changing the distribution of the display object further comprises:
changing a distribution of the other display objects by switching from the first display surface to the second display surface by the rotated effect according to the drag direction of the drag event.
